(19) United States
(12) Patent Application Publication
(10) Pub. No.: US 2026/0120012 A1
(43) Pub. Date: Apr. 30, 2026

(54) Systems and Methods for Resource Aggregation

(71) Applicant: Uber Technologies, Inc., San Francisco, CA (US)

(72) Inventors: Carolyn Buchanan, San Francisco, CA (US); Hamid Nazerzadeh, Menlo Park, CA (US); James Parker, San Francisco, CA (US)

(21) Appl. No.: 19/368,420

(22) Filed: Oct. 24, 2025

Related U.S. Application Data
(60) Provisional application No. 63/713,432, filed on Oct. 29, 2024.

(51) Int. Cl. G06Q 10/0631

(52) U.S. Cl. CPC G06Q 10/06311

(57) ABSTRACT

Systems and methods for gratuity aggregation. The system can determine an ephemeral cluster associated with a period of time that is representative of a geographic. The method includes determining a plurality of requests associated with a threshold level of gratuity within the geographic region to assign to the ephemeral cluster during the period of time. The method includes accessing vehicle data indicative of an availability of service providers capable of satisfying the plurality of requests during the period of time. The method includes generating an estimated earning distribution indicative of a predetermined gratuity for the respective requests assigned to the ephemeral cluster during the period of time. The method includes transmitting command instructions to a user device associated with a respective service provider to cause at least one request indicating the predetermined gratuity to be provided for display on the user device.

### FIELD

The present disclosure generally relates to using machine-learned models to generate a plurality of service assignments within a geographic region. More particularly, the present disclosure is directed to using machine-learned models to aggregate resources across the plurality of service assignments.

### BACKGROUND

Food delivery services allow a user to request a service that may be performed by a vehicle or service provider. For instance, a user may request, through a food delivery service application, a food delivery service having a pick-up location, a drop-off location, and items for delivery. A service provider can be assigned to perform the food delivery service for the user. This can include transporting the delivery of the items to the drop-off location.

### SUMMARY

Aspects and advantages of embodiments of the present disclosure will be set forth in part in the following description, or may be learned from the description, or may be learned through practice of the embodiments.

One aspect of the present disclosure is directed to a computer-implemented method. The method includes determining, using a first machine-learned model, an ephemeral cluster representative of a geographic region, wherein the ephemeral cluster is associated with a period of time. The method includes determining, using a second machine-learned model, a plurality of requests associated with the geographic region to assign to the ephemeral cluster during the period of time, wherein the plurality of requests are associated with a threshold level of gratuity. The method includes accessing vehicle data indicative of an availability of one or service providers capable of satisfying the plurality of requests within the geographic region during the period of time. The method includes generating, based on the plurality of requests and the vehicle data, an estimated earning distribution, wherein the estimated earning distribution is indicative of a predetermined gratuity associated with respective requests of the plurality of requests assigned to the ephemeral cluster during the period of time. The method includes transmitting one or more command instructions to a user device associated with a respective service provider of the one or more service providers to cause at least one request of the plurality of requests to be provided for display via a user interface of the user device, the at least one request indicating the predetermined gratuity.

In some implementations, the example method includes receiving user input data from the user device, the user input data indicating an acceptance of the predetermined gratuity. In some implementations, the example method includes assigning the respective service provider to the ephemeral cluster during the period of time.

In some implementations, the example method includes monitoring the ephemeral cluster during the period of time to identify one or more changed conditions, the one or more changed conditions indicative of at least one of a change in the vehicle data. In some implementations, the example method includes, based on the one or more changed conditions, generating an updated earning distribution during the period of time.

In some implementations of the example method, the one or more changed conditions is associated with the threshold level of gratuity.

In some implementations of the example method, the vehicle data comprises metrics associated with respective service providers of the one or more service providers, the metrics includes at least one of (i) an acceptance rate, (ii) a consumer rating, or (iii) a cancel rate.

In some implementations, the example method includes accessing execution data associated with the ephemeral cluster, the execution data indicative of real-time execution of the plurality of requests assigned to the ephemeral cluster during the period of time. In some implementations, the example method includes, based on the execution data, determining an actual earning distribution across the ephemeral cluster.

In some implementations, the example method includes determining that the actual earning distribution is above or below the estimated earning distribution. In some implementations, the example method includes determining an updated estimated earning distribution based on the actual earning distribution being above or below the estimated earning distribution, wherein the updated estimated earning distribution is associated with subsequent respective service providers assigned to the ephemeral cluster.

In some implementations, the example method includes determining, using the first machine-learned model, a plurality of ephemeral clusters representative of a plurality of geographic regions, wherein the plurality of geographic regions are associated with a threshold proximity to each other.

In some implementations, the example method includes accessing assignment data indicative of one or more assignments of the one or service providers to one or more ephemeral clusters. In some implementations, the example method includes, based on the assignment data, determining a size of the ephemeral cluster wherein the size correlates to a size of the geographic region associated with the ephemeral cluster.

In some implementations of the example method, the period of time is associated with at least one of (i) breakfast hours, (ii) lunch hours, (iii) dinner hours, or (iv) a rush hour period.

Another example aspect of the present disclosure is directed to a computing system. The computing system includes one or more processors and one or more tangible, non-transitory, computer readable media that store instructions that are executable by the one or more processors to cause the computing system to perform operations. The operations include determining, using a first machine-learned model, an ephemeral cluster representative of a geographic region, wherein the ephemeral cluster is associated with a period of time. The operations include determining, using a second machine-learned model, a plurality of requests associated with the geographic region to assign to the ephemeral cluster during the period of time, wherein the plurality of requests are associated with a threshold level of gratuity. The operations include accessing vehicle data indicative of an availability of one or service providers capable of satisfying the plurality of requests within the geographic region during the period of time. The operations include generating, based on the plurality of requests and the vehicle data, an estimated earning distribution, wherein the estimated earning distribution is indicative of a predetermined gratuity associated with respective requests of the plurality of requests assigned to the ephemeral cluster during the period of time. The operations include transmitting one or more command instructions to a user device associated with a respective service provider of the one or more service providers to cause at least one request of the plurality of requests to be provided for display via a user interface of the user device, the at least one request indicating the predetermined gratuity.

In some implementations, the example operations include receiving user input data from the user device, the user input data indicating an acceptance of the predetermined gratuity. In some implementations, the example operations include assigning the respective service provider to the ephemeral cluster during the period of time.

In some implementations, the example operations include monitoring the ephemeral cluster during the period of time to identify one or more changed conditions, the one or more changed conditions indicative of at least one of a change in the vehicle data. In some implementations, the example operations include, based on the one or more changed conditions, generating an updated earning distribution during the period of time.

In some implementations of the example computing system, the one or more changed conditions is associated with the threshold level of gratuity.

In some implementations of the example computing system, the vehicle data includes metrics associated with respective service providers of the one or more service providers, the metrics comprising at least one of (i) an acceptance rate, (ii) a consumer rating, or (iii) a cancel rate.

In some implementations, the example operations include accessing execution data associated with the ephemeral cluster, the execution data indicative of real-time execution of the plurality of requests assigned to the ephemeral cluster during the period of time. In some implementations, the example operations include, based on the execution data, determining an actual earning distribution across the ephemeral cluster.

In some implementations, the example operations include determining that the actual earning distribution is above or below the estimated earning distribution. In some implementations, the example operations include determining an updated estimated earning distribution based on the actual earning distribution being above or below the estimated earning distribution, wherein the updated estimated earning distribution is associated with subsequent respective service providers assigned to the ephemeral cluster.

In some implementations, the example operations include determining, using the first machine-learned model, a plurality of ephemeral clusters representative of a plurality of geographic regions, wherein the plurality of geographic regions are associated with a threshold proximity to each other.

In some implementations, the example operations include, accessing assignment data indicative of one or more assignments of the one or service providers to one or more ephemeral clusters. In some implementations, the example operations include based on the assignment data, determining a size of the ephemeral cluster wherein the size correlates to a size of the geographic region associated with the ephemeral cluster.

Yet another example aspect of the present disclosure is directed to one or more non-transitory computer readable media storing instructions that are executable by one or more processors to perform operations. The operations include determining, using a first machine-learned model, an ephemeral cluster representative of a geographic region, wherein the ephemeral cluster is associated with a period of time. The operations include determining, using a second machine-learned model, a plurality of requests associated with the geographic region to assign to the ephemeral cluster during the period of time, wherein the plurality of requests are associated with a threshold level of gratuity. The operations include accessing vehicle data indicative of an availability of one or service providers capable of satisfying the plurality of requests within the geographic region during the period of time. The operations include generating, based on the plurality of requests and the vehicle data, an estimated earning distribution, wherein the estimated earning distribution is indicative of a predetermined gratuity associated with respective requests of the plurality of requests assigned to the ephemeral cluster during the period of time. The operations include transmitting one or more command instructions to a user device associated with a respective service provider of the one or more service providers to cause at least one request of the plurality of requests to be provided for display via a user interface of the user device, the at least one request indicating the predetermined gratuity.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system according to example embodiments of the present disclosure;

FIG. 2 depicts an example data structure of a memory according to example embodiments of the present disclosure;

FIG. 3 depicts example geographic region clusters according to example embodiments of the present disclosure;

FIG. 4 depicts an example dataflow pipeline according to example embodiments of the present disclosure;

FIG. 5 depicts a flowchart of an example method according to example embodiments of the present disclosure;

FIG. 6 depicts a block diagram of an example system according to example embodiments of the present disclosure;

FIG. 7 depicts block diagrams of example systems according to example embodiments of the present disclosure.

### DETAILED DESCRIPTION

Generally, the present disclosure is directed to improved systems and methods for improving the efficiency of a back-end computing network that is programmed to assign service requests to service providers. For example, aspects of the present disclosure include AI-assisted aggregation and balanced allocation of service assignments for service providers in a geographic region, to intelligently reduce the computational load on the back-end network system.

For instance, a service provider may fulfill multiple service requests in a geographic region and gratuity offered for each request may vary drastically. Traditionally, service providers receive only the accumulation of gratuity offered by the requesting users across each of the service requests fulfilled by the service provider. In some instances, a group of service providers may coordinate to share equally in all gratuity received from all service requests fulfilled by the group. However, this approach fails to consider several factors such as the length of time worked by each service provider, the number of requests fulfilled by each service provider, external factors, etc., resulting in uncertain outcomes for the service providers.

Current systems lack the computing functionality to dynamically balance these dynamic factors. Instead, a computing system may utilize substantial processing resources to generate banners, notifications, reminders, etc. for transmittal and presentation in a user interface on the device of the requesting user. These frequent communications aim to remind the user of the potential for providing gratuity. However, these communications constrain network bandwidth resources, while also utilizing the processing and power resources of the user's device.

To help solve these and other technical problems, the present disclosure provides an aggregation system configured to intelligently facilitate the grouping of service requests within a geographic region that are associated with a threshold level of gratuity during a period of time such that a guaranteed gratuity earning distribution can be estimated prior to assignment of the service request to service providers. The estimated earning distribution may be presented as an offer to service providers to receive the guaranteed estimated earning distribution in exchange for fulfillment of service requests in these geographic regions. In this manner, the technology of the present can substantially reduce the computing resources utilized by current notification systems, while also reducing the high variance in earnings.

For example, the computing system may include a machine-learned clustering model (e.g., cluster definition model) configured to define ephemeral clusters that correspond to geographic regions. Example ephemeral clusters may include an ephemeral cluster associated with three blocks of a metropolitan area, a collection of neighborhoods in a suburban area, etc. The machine-learned clustering model may define the size (e.g., radius, etc.), and duration (e.g., lifespan, etc.) of the ephemeral clusters based on request data associated with a particular geographic region. For instance, the size of the ephemeral cluster may be determined by the density of service requests received within defined proximity of each other during a period of time. The period of time can include, for example, a portion of a day (e.g. breakfast time) or a portion of a week (e.g., holiday weekend, etc.).

The geographic region may be defined by a threshold distance (e.g., a radius) of any size or shape that may be defined on a map. For instance, a geographic region may include a portion of a downtown area or several square miles of a rural area. The duration may be defined by increases in service requests during certain periods of time such as morning commutes, lunch or dinner times, etc. By way of example, the computing system may receive a plurality of service requests which include a plurality of food items to be delivered to various destination locations within a geographic region during lunch time. While examples herein describe a food delivery service, the present disclosure is not limited to such embodiment and may be utilized in any type of consumer service.

The computing system may define a threshold gratuity level for the cluster indicating a minimum gratuity level needed to be assigned to the cluster. For instance, an earning distribution system may balance earning outcomes (e.g., guaranteed earning distributions) with market efficiency (e.g., assigning only high gratuity request to the cluster, reduction of available service providers to due cluster assignments, etc.) to determine a threshold gratuity level that incentivizes service providers to accept the guaranteed earning distribution while preventing adverse impacts to other service requests nearby such as increase in cancellations, rejection of lower gratuity requests, etc. In an embodiment, the gratuity aggregation system may include a monitoring system that monitors the threshold gratuity level, and initiates changes if conditions change during the period of time. Condition changes may include changes in volume of service requests, number of available service providers, difficulty in completing service requests, etc.

For instance, the computing system may include one or more cluster assignment machine-learned models configured to assign service requests and service providers to the cluster. The cluster assignment model may analyze service requests received by the computing system during the period of time (e.g., lunch, dinner, etc.) that have a destination location and a gratuity level within the threshold gratuity level and determine whether the request should be assigned to the ephemeral cluster. Once assigned, the service requests may be matched with service providers who “opt-in” to being assigned to the cluster. For instance, the cluster assignment model may access vehicle data including the all available service providers capable of fulfilling the services requests assigned to the cluster.

In some embodiments, for determining cluster assignment, the computing system can consider characteristics of the service providers including their past performance. Examples of past performance may include but are not limited to the acceptance rate, cancellation rate, or consumer rating of the service provider. In some embodiments, the cluster assignment model may determine service providers who are further away from the geographic area should be assigned to the cluster due to high performance during the fulfillment of previous service requests.

In some embodiments, the cluster assignment model may determine service providers should be assigned to more than one cluster. For instance, the clustering model may define a plurality of ephemeral clusters that are in close proximity to each other or overlap geographically. As such, the cluster assignment model may determine service providers should be assigned to multiple ephemeral clusters.

In some embodiments, the monitoring system may monitor the assignments service providers to determine whether conditions have changed during the period of time such that the criteria of selecting service providers should be updated to satisfy earning goals, objectives, etc.

The cluster assignment model may determine service requests that satisfy the threshold gratuity level and service providers of the available service providers to assign to the cluster. The computing system may transmit computing instructions to user devices associated with the selected services providers to render on a user interface display an offer of the guaranteed earning distribution. Once accepted, the service providers may be assigned to the cluster for the period of time (e.g., lifespan of the cluster). In some embodiments, a matching system may be used to match the service providers to services request once assigned to the cluster.

Once the period of time has expired, the computing system may distribute the guaranteed earning distribution to each of the service providers assigned to the cluster. In an embodiment, the actual earning distribution (e.g., total gratuity earned by the service providers during the period of time) may differ from the estimated earning distribution. The gratuity aggregation system may utilize the actual earning distribution as input to further train the machine-learned models improving on predictions of the estimated earning distributions.

The technology of the present disclosure can provide a number of technical effects and benefits. For instance, aspects of the described technology can improve the efficiency of computing system by utilizing machine-learned models to group service requests and service providers in ephemeral clusters prior to matching simplifying the matching process. Furthermore, the machine-learned models may be further trained to increase in efficiency and accuracy over time. The present system also preserves computing resources by defining ephemeral clusters which terminate once service requests have been fulfilled, thereby allowing the computing system to reallocate computing resources to other tasks.

Advantageously, the multi-model architecture can provide a number of technical improvements for the performance of the computing systems. For instance, by using a first machine-learned model to determine ephemeral clusters and a second machine-learned model to determine requests to assign to the ephemeral cluster, the computing system is able to properly dedicate its computing resources to more discrete tasks at each stage. For example, the cluster definition model can focus on the tasks of cluster analysis of service requests, without concern on temporal analysis, while the assignment model determines the appropriate service requests to assign. This helps to reduce the complexity of training or building heuristics for the models. Furthermore, the described resource aggregation techniques allow the computing system to assign an match new service requests in a geographic region with higher accuracy and efficiency, while also improving user experiences.

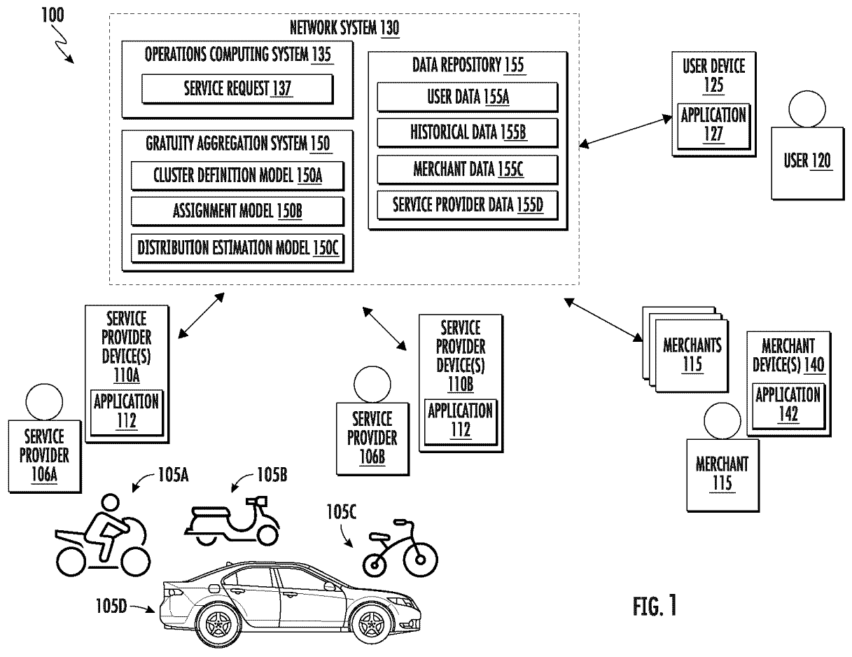

FIG. 1 depicts a block diagram of an example system according to example embodiments of the present disclosure. The example system 100 depicts an example food delivery implementation for example purposes only. The present disclosure is not limited to such embodiment and may be implemented in any type of service (e.g., transportation, etc.) for users. As illustrated in FIG. 1, system 100 can include one or more vehicles 105A-D (e.g., a car, scooter, motorcycle, bicycle) and one or more service provider devices 110A-B that can be associated with one or more service providers 106A-B. In some examples, the one or more service providers are humans (e.g., that can operate a vehicle). In some examples, the service provider can be non-human (e.g., vehicle, autonomous vehicle, autonomous robot). The one or more service providers 106A-B and the one or more service provider devices 110A-B (e.g., an onboard tablet, a mobile device of a service provider) can be associated with the one or more vehicles 105A-D. The service provider devices 110A-B can include an application 112 associated with a food delivery service entity, which can run on the service provider devices 110A-B.

The computing system 100 can include one or more merchants 115. The computing system can include one or more merchants 115. The network system 130 can obtain and store data from merchants 115. For instance, data can be stored in data repository 155. Data repository 155 can include user data 155A associated with one or more users, historical data 155B, merchant data 155C, and service provider data 155D. User data 155A can include data associated with one or more users (e.g., user 120). Historical data 155B can include data associated with prior use of services of a user, preference of a user, service provider data, historic packing time, and the like. Merchant data 155C can include data associated with a merchant such as merchant inventory, merchant location, merchant item preparation time, merchant time to pack time, and the like. The inventory data associated with merchants 115 can be used to determine what item offerings to present to user 120 via user device 125 (e.g., via software application such as application 127). Service provider data 155D can include data associated with one or more service providers (e.g., service provider 106A, service provider 106B) such as a list of service providers that are online, a status, a location, a vehicle capacity, a vehicle type, or service provider preferences. A status of a service provider can include that the service provider is currently providing a service, is available to provide a new service, etc. A location can include a past location, current location, future location, etc. Service provider preferences can include types of services, types of routes, location of the service, etc.

The merchants 115 (or service provider 106A and service provider 106B) can receive data indicative of a food delivery service request from a user 120. For example, the user 120 can submit a request through a user device 125 associated with the user (e.g., via a software application such as application 127). A network system 130 can include a computing system associated with a service entity that can facilitate a request for services from user 120. An operations computing system 135 associated with the food delivery service entity can facilitate a request for services from user 120. For example, user 120 can submit a food delivery service request through a user device 125 associated with the user 120 (e.g., via a software application such as application 127). Operations computing system 135 can receive a food delivery service request for a service request 137 from a user device 125. For instance, the request can include a first item that is in stock with a merchant 115. The operations computing system 135 can transmit data indicative of the service request 137 to a merchant device 140 associated with a merchant 115 (e.g., via a software application such as application 142).

The operations computing system 135 can receive data indicative of the merchant 115 accepting an order request (e.g., grocery items being packed, estimated time to pack grocery items, food being prepared, estimated preparation time). The operations computing system 135 can send a request to a service provider device 110A associated with a service provider 106A or a service provider device 110B associated with service provider 106B to complete a portion of the service request 137 (e.g., via a software application such as application 112). For instance, the operations computing system 135 can transmit data indicative of a first portion of service request 137 (e.g., a first service assignment) to service provider device 110A associated with service provider 106A and data indicative of a second portion of service request 137 (e.g., a second service assignment) to service provider device 110B associated with service provider 106B.

Additionally, or alternatively, the operations computing system 135 can receive data indicative of service provider 106A and service provider 106B accepting an order request (e.g., to deliver items, transport items, transport people, etc.). The operations computing system 135 can send a request to a service provider device 110A associated with a service provider 106A or service provider device 110B associated with service provider 106B to complete a portion of the service request 137 (e.g., via a software application such as application 112). For instance, the operations computing system 135 can transmit data indicative of a first portion of the service request 137 (e.g., a first service assignment) to service provider device 110A associated with service provider 106A and data indicative of second portion of the service request 137 (e.g., a second service assignment) to service provider device 110B associated with service provider 106B. In some implementations, the first portion of the service request 137 can include one or more items for service provider 106A to retrieve from a first physical location associated with a merchant. In some implementations, the second portion of the service request 137 can include one or more items for service provider 106B to retrieve from a second physical location associated with a merchant.

The network system 130 can include a gratuity aggregation system 150. The gratuity aggregation system 150 can include a combined (or independent) cluster definition model 150A, an assignment model 150B, and a distribution estimation model 150C. The cluster definition model 150A can determine an ephemeral cluster representative of a geographic region that includes service requests 137. For instance, the cluster definition model 150A can access service requests 137 received by the network system 130 during a period of time (e.g., lunch, dinner, etc.) and determine an ephemeral cluster where the service requests 137 may be assigned for the period of time. The assignment model 150B can assign service requests 137 and service providers 106A-B to the ephemeral clusters during the period of time such that the service providers 106A-B (e.g., assigned to the cluster) can be assigned to service request 137 that are assigned to the cluster. In an embodiment, the assignment model 150B can include sub-models (e.g., request assignment model, service provider assignment model, etc.). The distribution estimation model 150C can generate, based on the service request 137 and the service providers 106A-B, an estimated earning distribution (e.g., a predetermined gratuity) for the service providers who “opt-in” to execute the service requests 137 assigned to the cluster during the period of time. The network system 130 can transmit data indicative of the predetermined gratuity for display via service provider devices 110A-B (e.g., via a software application such as application 112).

The network system 130 can include a data repository 155. Data repository 155 can include user data 155A (e.g., data associated with user 120), historical data 155B (e.g., data associated with user 120, data associated with merchant(s) 115, data associated with service provider 106A and service provider 106B), merchant data 155C (e.g., real-time data associated with merchants 115, merchant inventory associated with merchants 115, merchant location information associated with merchants 115), service provider data 155D (e.g., data associated with service provider 106A or service provider 106B), or any other relevant data (e.g., system-level data associated with a plurality of users, expected demand).

The gratuity aggregation system 150 can determine a pre-determined gratuity for the service providers 106A-B that guarantees an associated level of gratuity using the combined (e.g., independent) cluster definition model 150A, assignment model 150B, and the distribution estimation model 150C. For example, the operations computing system 135 can obtain data indicative of a plurality of service requests 137 (e.g., submitted by users 120) that indicate delivery locations and merchant locations (e.g., associated with merchant 115A and merchant 115B). In response to obtaining data indicative of the service requests 137 and merchant locations, the gratuity aggregation system 150 can access service provider locations (e.g., associated with service providers 106A-B) to identify service provider that are capable of fulfilling the service requests 137. The cluster definition model 150A can generate an ephemeral cluster corresponding with a geographic region that encapsulates one or more of the service request 137 (e.g., delivery locations, merchant locations, etc.). For instance, 10 out of 20 service requests 137 received during a lunch time period (e.g., 11 AM-12 PM, 12 PM-2 PM, etc.) may indicate respective delivery locations within a 4 block radius of each other. The cluster definition model 150A can determine an ephemeral cluster that corresponds in size (e.g., 4 block radius) and time (e.g. lunch time period) to the 10 request.

The assignment model 150B can assign the 10 service requests already received by the network system 130 to the ephemeral cluster and other service requests received by the network system 130 during the lunch time period that satisfy a threshold gratuity level. For example, the distribution estimation model 150C can generate an estimated earning distribution for service providers 106A-B that fulfill service requests 137 assigned to the ephemeral cluster. The distribution estimation model 150C can consider data such as the associated gratuity offered by the users 120 at the time the service request was submitted, historical data 155B indicating previous gratuity level trends (e.g., predicted gratuity) for users 120 associated with the service requests 137, etc. The distribution estimation model 150C can determine, based on the number of service requests 137, the associated gratuity for each service request 137, and the number of service providers 106A-B needed to fulfill the service requests a threshold level of gratuity which sustains the estimated earning distribution for each service provider 106A-B assigned to the ephemeral cluster. Subsequent service requests 137 received by the network system 130 that meet or exceed the threshold level of gratuity may also be assigned to the ephemeral cluster during the lunch period of time.

Once the ephemeral clusters have been determined and service requests 137 have been assigned, the assignment model 150B (e.g., or a sub-model) can determine service providers 106A-B to assign to the ephemeral clusters. For example, the service providers 106A-B may “opt-in” to the ephemeral cluster after accepting the pre-determined gratuity amount. By way of example, the operations computing system 135 can provide data for display on a service provider device 110A-B (e.g., via application 112) indicative of the offer to “opt-in”, join, or otherwise consent to being added the ephemeral cluster to fulfill the service requests 137 within the associated geographic region in exchange for the guaranteed (e.g., pre-determined) gratuity.

The service providers 106A-B can provide user input indicating their intent to “opt-in” or join by accepting or indicate their intent to decline the invitation by “rejecting” the request. For instance, user input from the service providers 106A-B can be provided directly into application 112. Additionally, or alternatively, user input can be provided via an application programing interface (API) or a third-party application. Data indicative of the acceptance or rejection of the request can be provided to operations computing system 135. Service providers 106A-B “opt-in” can be assigned to the ephemeral cluster where they can be matched by a matching system to respective service requests 137 for fulfillment. The matching system may be a sub-system of the gratuity aggregation system or an independent system within the network system 130.

At the end of the lunch time period, the ephemeral cluster may terminate and the gratuity aggregation system 150 can distribute, at a minimum, the estimated earnings (e.g., predetermined gratuity) to the service providers 106A-B. Any underspend accumulated gratuity (e.g., additional gratuity received above the estimated earning distribution) may be distributed proportional to the service providers 106A-B.

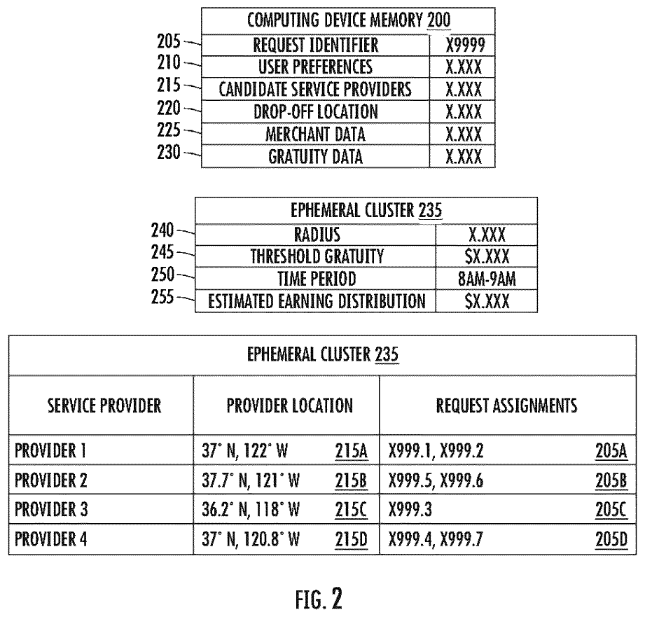

As described herein, system 100 can include a data repository 155. An example of data that can be stored in or associated with data repository 155 is described with regard to FIG. 2. FIG. 2 depicts example data stored in computing device memory 200. Example data can include a request identifier 205, user preferences 210, candidate service providers 215, drop-off location 220, merchant data 225, or gratuity data 230. Gratuity data 230 can include data associated with a request identifier 205 (e.g., service request 137).

By way of example, a request identifier 205 can be a request identifier associated with the food delivery service request (e.g., service request 137). Request identifier 205 can be associated with order request data. Order request data can include a plurality of items in an order. For instance, the computing system can obtain data indicative of a service request 137 including a request for at least a first item and a second item to be transported to a destination location (e.g., drop-off location 220).

User preferences 210 can include preferences associated with the user indicative of preferences on brands, cuisine, time of orders, quantity of orders, or any other data associated with a user preference. In an embodiment, user preferences 210 can include gratuity preferences (e.g., default 10%, 15%, etc.). The user preferences 210 can be accessed based on metadata included in the service request such as an encrypted identifier associated with the user that allows the operations computing system 135 to access data for the particular user (e.g., from stored user profile).

Candidate service providers 215 can include data indicative of a plurality of candidate service providers available to facilitate completion of one or more current or future food delivery service requests. For instance, candidate service providers 215 can include data associated with a current number of active service providers within a geographic region. Candidate service providers 215 can include information about each respective service provider. For instance, candidate service providers 215 can include data indicative of preferences of respective service providers, location of respective service providers, and the like. In an embodiment, candidate service providers 215 can include performance metrics associated with respective service providers. Performance metrics can include an acceptance rate, a consumer rating, a cancel rate, or any other metrics that indicate the past performance of the respective service provider. The drop-off location 220 can include data indicative of a destination location for the items associated with the food delivery service request to be dropped off by one or more service providers.

By way of example, a current number of active service providers (e.g., service providers 106A-B) within a geographic region can be compared to a threshold number of active service providers within a geographic region. For instance, a threshold number of active service providers can be indicative of a number of service providers being active in a geographic region to adequately fulfill a plurality of current or predicted future service requests. A number of active service providers that exceeds the threshold number of active service providers can be indicative of a surplus of available service providers to perform expected vehicle service requests within the geographic region. A number of active service providers that does not exceed the threshold number of active service providers can be indicative of an undersupply of active service providers in a geographic area to perform expected vehicle service requests within the geographic region.

The comparison of the current number of active service providers within a geographic region can be compared to the threshold number of active service providers to determine whether to facilitate aggregated gratuity (e.g., generate an ephemeral cluster) and offer a service provider (e.g., service provider 106A-B) an option to “opt-in”. For instance, the gratuity aggregation system 150 can balance dynamic factors such as earning outcomes (e.g., guaranteed earning distributions) with market efficiency (e.g., assigning only high gratuity request to the cluster, reduction of available service providers to due cluster assignments, etc.). Additionally, or alternatively, the comparison can be used to determine respective service providers of the active service providers to invite to the ephemeral clusters.

In some implementations, the comparison of the current number of active service providers to the threshold can include consideration of the heading of each respective service provider (e.g., where the service provider is going). For instance, if a service provider is far from a home location and close to a time where the service provider normally stops performing delivery services, the service provider can be considered active or available for a leg (e.g., of a multi-leg request) that takes the service provider closer to the service provider's home location. Additionally, or alternatively, if a service provider is currently fulfilling an order and can add a leg of a multi-service provider order request fulfillment in conjunction with the service provider's current order fulfillment, the network computing system 130 can send a request to the service provider to fulfill multiple requests concurrently. The general availability of active service providers in or within a threshold proximity of the geographic region can be considered by the gratuity aggregation system 150 in determining whether to generate an ephemeral cluster should be generated and whether to invite respective service providers.

By way of example, a heading of a respective service provider can be determined using data indicative of service provider location or service provider online pattern. For instance, a service provider location can be determined using GPS pings, Wi-Fi, IP address, device sensor data, cellular network, or user input. A service provider online pattern can include a past history associated with a service provider. For instance, past history associated with a service provider can include prior service completion history, prior service request denial history, or prior travel patterns, prior online hours history (e.g., times of day a service provider is accepting service requests).

The service provider's heading or online pattern can be used to forecast a service provider's availability for a leg of the combined service, or a service request assigned to an ephemeral cluster. For instance, in the event that the computing system determines that the heading of the service provider is pointed in a direction away from a merchant location associated with a service request, the outer bounds of the ephemeral cluster, etc., the computing system may determine that the service provider is not available to be assigned to the ephemeral cluster. Additionally, or alternatively, the network computing system 130 may forecast that a service provider may not be available for service requests assigned to the ephemeral cluster in the event the service provider's online pattern indicates that the service provider typically declines such type of services within the geographic region associated with the ephemeral cluster, is likely to go offline soon, etc.

Merchant data 225 can include data associated with a plurality of merchants (e.g., merchants 115). For instance, merchant data 225 can include the location of merchant, inventory of items offered by the merchant, hours of the merchant, or other information associated with the merchant.

The ephemeral cluster 235 can include data indicative of the radius 240 (e.g., shape, size, etc.) of the ephemeral cluster relative to map data, the threshold gratuity 245 associated with the ephemeral cluster 235, the time period 250 (e.g., lifecycle duration, etc.) that the ephemeral cluster will persist, and the estimated earning distribution 255 for service providers assigned to the ephemeral cluster 235.

By way of example, the ephemeral clusters 235 can be generated by the cluster definition model 150A to help reduce the high variance in earnings by service providers in a geographic region. For instance, the cluster definition model 150A can determine the radius 240 (e.g., size, shape, etc.) of the ephemeral cluster 235 by aggregating a plurality of request identifiers 205 (e.g., service request 137) received by the network computing system 130 based on a threshold proximity (e.g., drop-off location 220). For example, the ephemeral cluster 235 can include a radius 240 that encapsulates all service requests that include a drop-off location 220 are within a 5 mile radius of each other.

The cluster definition model 150A can determine the time period 250 for which the ephemeral cluster will persist. The time period 250 can algin to an influx of service requests 137 that are received by the network system 130 (e.g., based on historical data 155B, promotional campaigns, etc.). For instance, the ephemeral cluster 235 can persist for a defined time period 250 (e.g., 2 hours, 4 hours, etc.) and terminate at the expiration of the time period 250. Data included in the ephemeral cluster 235 at the expiration of the time period 250 may be stored in the data repository 155. In an embodiment, the data included in the ephemeral cluster 235 may be used to further train the cluster definition model 150A, assignment model 150B, distribution estimation model 150C, etc.

The distribution estimation model 150C can determine the threshold gratuity 245 and estimated earning distribution 255 associated with the ephemeral cluster 235. For example, the distribution estimation model 150C can analyze the gratuity data 230 indicating gratuity offered by the requesting users of the service requests 137 (e.g., request identifiers) that are within the radius 240 of the ephemeral cluster 235. In some implementations, the estimated earning distribution 255 can analyze the user preferences 210 indicating gratuity preferences or past gratuity trends by the requesting user to predict an estimated gratuity that will be associated with the request identifier 205 within the radius of the ephemeral cluster 235.

For instance, the distribution estimation model 150C can determine the estimated earning distribution by aggregating the gratuity data 230 across all request identifiers 205 that are located (e.g., drop-off location 220, etc.) within the radius 240 of the ephemeral cluster 235. The aggregated gratuity data may be divided equally across an estimated number of service providers needed to fulfill each of the service requests 137 to determine the estimated earning distribution.

In an embodiment, the gratuity data 230 can be derived for each of the service requests 137. For example, gratuity data 230 can be determined for a service request 137 based on a points system. The point system may consider additional factors which can influence gratuity data 230 such as the time (e.g., traffic etc.), distance, trip complexity, etc. associated with each service request 137. The additional factors can be real-time gratuity data. Real-time gratuity data can include gratuity offered any time after the initial service request 137 is received by the network system 130 or has been fulfilled.

In an embodiment, the distribution estimation model 150C can estimate the ‘points’ of a given service request 137 and then multiply that by the estimated average gratuity data 230 per service request to determine the estimated earning distribution. The computation of the estimated earning distribution can be biased downward (e.g., lower). For instance, estimated earning distribution can include a guaranteed (e.g., pre-determined) estimated earning distribution.

In an embodiment, the distribution estimation model 150C can determine an updated estimated earning distribution based on changed conditions. Changed conditions can include changes in service provider data 155D (e.g., vehicle data) indicating a change in the available service providers, changes in the threshold gratuity 245 (e.g., an increase, decrease, etc.) based on subsequent service requests 137 received during the time period 250, or any other external conditions.

By way of example, the distribution estimation model 150C can detect a change in vehicle data (e.g., service provider data 155D) indicating that the number of available service providers is dropping near a lower bound threshold of service providers needed to fulfill service requests 137 within the geographic region (e.g. ephemeral cluster 235). Based on the changed condition, the distribution estimation model 150C can determine an updated estimated earning distribution which is higher to incentivize more service providers to fulfill the service requests 137 within the ephemeral cluster 235.

In another example, the distribution estimation model 150C can detect a change in the execution data. Execution data can include data indicating real-time execution (e.g., fulfillment) of the service requests 137 assigned to an ephemeral cluster 235 during the time period 250. For instance, increased traffic may cause service providers to fall behind on timely fulfillment. In an embodiment, the distribution estimation model 150C can determine that the actual earning distribution across the ephemeral cluster 235 will be lower due to a decrease in the number of service request 137 that can be fulfilled during the time period 250. For example, traffic congestion that blocks a highway for multiple service providers can indicate that those service providers will be extremely late in fulfilling their matched service requests 137. As such the gratuity data 230 associated with these late service requests 137 may decrease. In response to the execution data, the distribution estimation model 150C can determine an overspend (e.g., actual earning distributions) for the ephemeral cluster 235.

In some implementations, service requests 137 located within the radius 240 of the ephemeral cluster 235 may not be assigned to the ephemeral cluster 235. For instance, the distribution estimation model 150C can determine a threshold gratuity 245. The threshold gratuity 245 can indicate a minimum gratuity level that can be associated with request identifiers 205 to be assigned to the ephemeral cluster. The threshold gratuity 245 may maintain at least the estimated earning distribution 255 determined by the distribution estimation model 150C.

By way of example, the distribution estimation model 150C can determine the estimated earning distribution 255 for the ephemeral cluster 235 is 5 dollars for each service request fulfilled by the service provider within the geographic region. In an embodiment, one or more service requests 137 may be received by the network computing system 130 indicating no gratuity (e.g., $0 in gratuity data 230). The assignment model 150B can compare the gratuity data 230 to the threshold gratuity 245. Based on the comparison indicating the one or more service requests 137 are below the threshold gratuity 245 (e.g., indicating no gratuity), the assignment model 150B may determine the one or more service requests should not be assigned to the ephemeral cluster 235. In other embodiments, the assignment model 150B can also determine whether the one or more service requests should be assigned based on the comparison of the gratuity data 230 to the threshold gratuity 245 and user preferences 210 or historical data 155B. For instance, the gratuity data 230 may indicate a value less than the threshold gratuity 245, however, user preferences 210 or historical data 155B can indicate that the user provides (e.g., preference, historically, etc.) a gratuity (e.g., gratuity data 230) above the threshold gratuity 245. For example, the user may historically provide gratuity data 230 after the service has been fulfilled (e.g., after delivery).

Additionally, or alternatively, the ephemeral cluster 235 can include the assignments (e.g., matches) of request identifiers 205 to service providers. For instance, the assignment model 150B can assign the service requests 137 and service providers to the ephemeral cluster 235 where they may be matched. A matching system can be used to match the service providers to the service requests within the ephemeral cluster 235. The matching system can be included as a sub-system of the assignment model 150B, a separate system within the gratuity aggregation system 150, or an independent system within the network system 130.

The matches can indicate the service provider, the provider location 215A-D (e.g., location of the service provider) and matched request assignments 205A-D. The provider location of the service provider (e.g., geographic location, GPS coordinates, latitude and longitude) can indicate the current or future location of the service provider. In an embodiment, the provider location 205A-D can be iteratively updated as the service provider traverses the geographic region within the radius. The request assignments 205A-D can be associated with the service providers based on the provider location 215A-D (e.g., closer proximity to drop-off location 220, etc.) or other dynamic factors.

In some implementations, merchant A 230 and merchant B 260 can have overlapping inventory. For instance, as depicted in FIG. 2, merchant A and B both have inventory of item identifiers apple (e.g., inventory 240A and inventory 270A), orange (e.g., inventory 240B and inventory 270B). Merchant A has zero inventory of item identifier eggs (e.g., inventory 270D) and merchant B 260 has no inventory of item identifier diet soda (e.g., inventory 240C) or item identifier milk (e.g., inventory 270C). In an example, the computing system can determine that a first item (e.g., item identifier diet soda based on inventory 240C or item identifier milk based on inventory 240D) is available at a first grocery location (e.g., merchant A 230) and unavailable at a second grocery location (e.g., merchant B 260) and that a second item (e.g., item identifier eggs based on inventory 270D) is available at a second grocery location (e.g., merchant B 260) and unavailable at the first grocery location (e.g., merchant A 230).

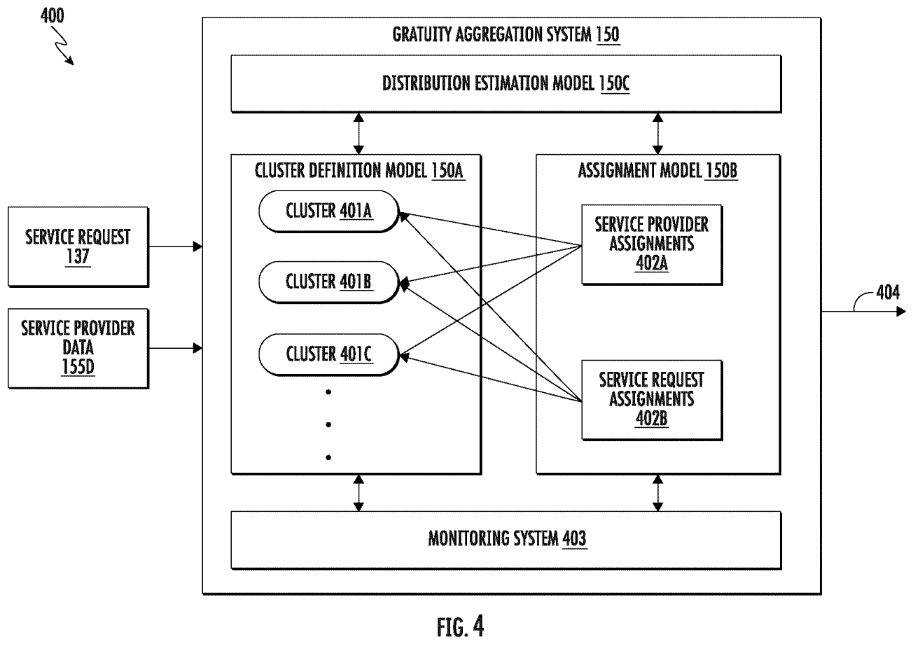

In some embodiments, a monitoring system can be used to monitor the data stored, processed, and output by gratuity aggregation system 150. For instance, a monitoring system may determine that the estimated earning distribution 255 does not adequately balance dynamic factors. By way of example, the estimated earning distribution 255 may be too low such that an insufficient number of service providers “opt-in” to be assigned to the ephemeral cluster 235. In another embodiment, the monitoring system may also determine that the number of request assignments 205A-D (e.g., service requests 137) assigned to the ephemeral cluster 235 is causing adverse market impacts (e.g., lower quality, increase cancellations, late deliveries, etc.) on the surrounding area. The monitoring system may monitor the data and the gratuity aggregation system 150 and provide input (e.g., updating model parameters, terminating ephemeral clusters, etc.) to mitigate adverse effects. An example of the monitoring system is further described with reference to FIG. 4.

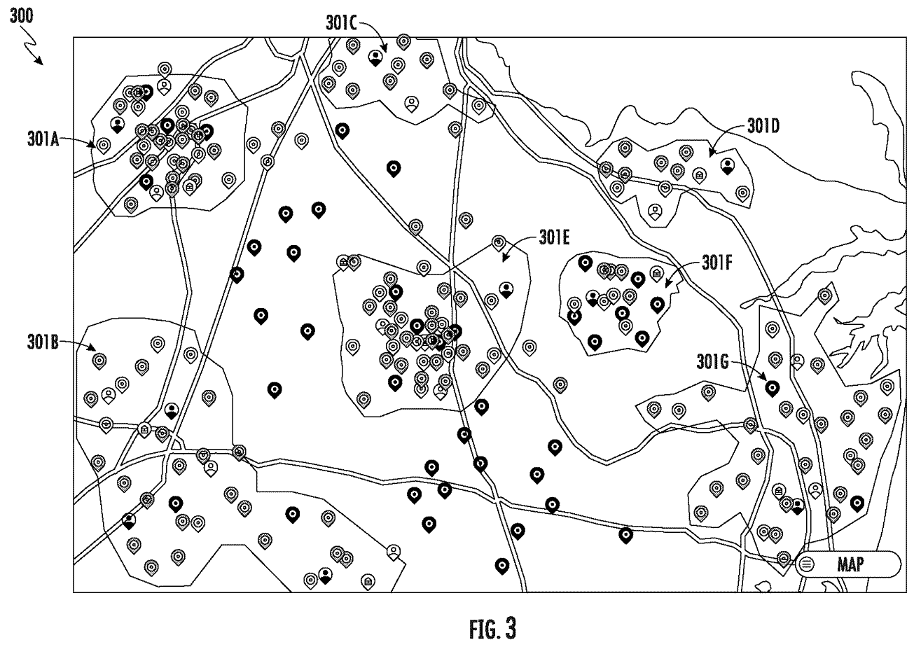

As depicted in FIG. 3, a map 300 of a geographic region can include a plurality of ephemeral clusters 301A-G. For instance, the map 300 can include map data representative of cities, towns, municipalities, etc. The ephemeral clusters 301A-G depicted on the map 300 can include various sizes and shapes. For instance, ephemeral cluster 301A can include a more circular shaped radius and ephemeral cluster 301B can include a more elongated radius. Each of the ephemeral clusters 301A-G can be generated (e.g., by the cluster definition model 150A concurrently or iteratively. The ephemeral clusters 301A-G can be independent of each other and include different time periods 250, threshold gratuity 245, and estimated earning distributions 255. For instance, the ephemeral clusters 301A-G can correlate to data structures (e.g., ephemeral clusters 235) where request assignments 205A-D can be assigned during the respective time period 250.

By way of example, the gratuity aggregation system 150 can determine at 8 AM that an influx of service requests 137 are being received by the network computing system 130 across the map 300. The cluster definition model 150A can analyze the requests and determine ephemeral cluster 301A and ephemeral cluster 301G based on a threshold density of service requests within a threshold proximity of each other. The threshold density can include any measure of frequency such as requests per second, requests per minute, etc. In an embodiment, the threshold density can be associated with the gratuity data 230. For instance, the threshold density can include a threshold number of service requests where the gratuity data 230 indicates a high (e.g., above a threshold) gratuity trend, average, etc.

The cluster definition model 150A, based on the service requests satisfying the threshold density, can determine the radius 240 and time period 250 associated with ephemeral cluster 301A and ephemeral cluster 301G. For example, the cluster definition model 150A can determine an outer boundary that encapsulates the aggregated service requests within the threshold proximity of each other. As shown the outer boundary of ephemeral cluster 301A may include a plurality of service requests and exclude nearby service requests. For instance, service requests that are nearby may exceed an average or threshold distance proximity (e.g., outlier, etc.) and not be included within the radius 240 of the ephemeral cluster 301A. In an embodiment, nearby service requests may be excluded due to failure to satisfy the threshold gratuity 245 configured for the ephemeral cluster 301A.

Ephemeral cluster 301G may include outer boundaries that include all nearby service requests. For instance, ephemeral cluster 301G may include a portion of the geographic region that is easier to traverse (e.g., less traffic, rural areas, etc.) as such, the proximity of service requests to each other may be increased allowing for more efficient travel times for service providers to fulfill the service requests timely. In another embodiment, the radius of the ephemeral cluster 301G may be determined based on the candidate service providers 215. For instance, the cluster definition model 150A can determine that there is a sufficient supply of service providers capable of fulfilling the influx of service requests. As such the size and shape of the ephemeral cluster 301G can be determined based on the location of the active service providers.

The gratuity aggregation system 150 can determine that the influx of service requests will normalize (e.g., reduced to a constant frequency) within a time period 250. For example, based on historical data 155B, the gratuity aggregation system 150 can determine that an influx of breakfast service requests has historically occurred from 8 AM to 10 AM for the portion of the geographic region associated with ephemeral cluster 301A and 8 AM-9 AM for ephemeral cluster 301G. As such, the cluster definition model 150A can determine the time periods of 250 according for each of the ephemeral clusters 301A, 301G.

The ephemeral clusters 301A, 301G can each include a different radius 240, threshold gratuity 245, time period 250, and estimated earning distribution 255 based on the service requests assigned to the respective clusters and the service providers fulfilling the service requests.

In an embodiment, a particular service provider can be assigned to more than one ephemeral cluster 301A-G concurrently. By way of example, ephemeral cluster 301E and ephemeral cluster 301F may be within a threshold travel distance such that a particular service provider can fulfill service requests assigned to both ephemeral clusters 301E, 301F in a timely manner. A threshold travel distance can include the time and/or distance needed to travel from one service request (e.g., drop-off location 220) to another (e.g., merchant data 225, pick-up location, etc.). For instance, the assignment model 150B can consider the provider location 215A-D in determining whether to assign the particular service provider to the ephemeral clusters 301E, 301F.

The cluster definition model 150A can iteratively and concurrently determine ephemeral clusters 301A-G at varying and overlapping time periods 250. For instance, at 9:30 AM, the network computing system 130 may receive an influx of service requests within a threshold proximity of each other and generate ephemeral clusters 301B, 301E. Based on the data (e.g., gratuity data 230, drop-off location 220, historical data 155B, etc.) the cluster definition model 150A can determine the radius 240 and time period 250 associated with the ephemeral clusters 301B, 301E. The assignment model 150B and the distribution estimation model 150C can determine the requests assignments, service providers, threshold gratuity 245, and estimated earning distribution 255 for each of the ephemeral clusters 301B, 301E.

In an embodiment, a monitoring system can be used to monitor the assignments of service providers to determine whether conditions have changed during the period of time such that the criteria of selecting service providers should be updated to satisfy earning goals, objectives, etc. An example of a monitoring system is further described with reference to FIG. 4.

FIG. 4 depicts an example dataflow pipeline according to example embodiments of the present disclosure. The following description of dataflow pipeline 400 is described with an example implementation in which a gratuity aggregation system 150 accesses service requests 137, service provider data 155D, and utilizes a plurality of machine-learned models to reduce the variance of earnings by service providers within a geographic region.

For instance, a cluster definition model 150A can define (e.g., radius 240, time period 250, etc.) a plurality of ephemeral clusters 401A-C that represent geographic regions. An assignment model 150B can populate the ephemeral clusters 401A-C with service request assignments 402B that satisfy the respective parameters of each ephemeral cluster 401A-C. The distribution estimation model 150C can determine, based on the service provider data 155D and the service request assignments 402B for each ephemeral cluster 401A-C, an estimation earning distribution 255 (e.g., pre-determined gratuity) for each ephemeral cluster 401A-C.

Once the estimated earning distribution 255 has been determined, the assignment model 150B can generate service provider assignments 402A. For instance, the gratuity aggregation system 150 can transmit output 404 to a user device (e.g., service provider device 110A-B, etc.). The output 404 can include command instructions to display via a user interface of the user device an invitation to “opt-in” or join the ephemeral cluster and display the predetermined gratuity. Service providers that accept (e.g., “opt-in”) the invitation to join the ephemeral cluster 401A-C can be assigned to the ephemeral cluster 401A-C. For instance, in response to user input (e.g., via the service provider device 110A-B, etc.) the assignment model 150B can execute the service provider assignments 402A by assigning the service providers to the ephemeral cluster 401A-C. Once assigned, the service providers may be matched to service requests for fulfillment.

A monitoring system 403 can monitor the ephemeral clusters 401A-C and respective assignments (e.g., service provider assignments 402A, service request assignments 402B, etc.) to balance earning outcomes (e.g., guaranteed earning distributions), objectives, etc. with market efficiency (e.g., assigning only high gratuity request to the cluster, reduction of available service providers to due cluster assignments, etc.).

The service requests 137 can be received from a plurality of users 120 via user devices 125. For instance, the service requests 137 can include a various items that are in stock with one or more merchants 115A within a geographic region. The service provider data 155D can be accessed from the various service provider devices 110A-B and include data associated with one or more service providers (e.g., service provider 106A, service provider 106B) such as a list of service providers that are online, a status, a location, a vehicle capacity, a vehicle type, etc.

The gratuity aggregation system 150 can include software running on one or more servers of the network system 130. In some implementations, the gratuity aggregation system 150 can be a standalone system configured to communicate with the network system 130. The gratuity aggregation system 150 can be configured to access the service requests 137 and service provider data 155D to determine, using a machine-learned cluster definition model 150A, an ephemeral cluster representative of a geographic region. For instance, the service requests 137 can indicate locations (e.g., merchant location, drop-off location 220, etc.) associated with the service request 137 and the service provider data 155D can include the locations of the service providers available to fulfill the service requests 137.

A machine-learned cluster definition model 150A (e.g., machine-learned clustering model) may be or otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The cluster definition model 150A may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled service requests that have labels indicating the aggregated locations and times of service requests in a geographic region. In some examples, the training data may include simulated training data (e.g., training data obtained from simulated scenarios, inputs, configurations, geographic regions, etc.).

Additionally, or alternatively, the model trainer(s) may perform unsupervised training techniques using unlabeled training data. By way of example, the model trainer(s) may train one or more components of a machine-learned model to perform parking space detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The cluster definition model 150A may be a machine-learned clustering model configured to aggregate (e.g., group) the service requests 137 to determine ephemeral clusters 401A-C. For instance, a clustering model can identify groups of similar records (e.g., service requests 137) and label the records according to the group to which they belong by performing a cluster analysis. A cluster analysis can include any statistical method for processing data by organizing the data into groups (e.g., ephemeral clusters 41A-C) based on how closely associated the data is. The present disclosure is not limited to such embodiment, and any type of clustering techniques can be used such as connectivity-based, constrained, density-based, distribution-based, fuzzy, etc.

By way of example, the cluster definition model 150A can perform a cluster analysis on the service requests 137 to organize the respective requests based on how closely related the requests are. For instance, service requests 137 which include locations (e.g., drop-off locations 220, merchant locations, etc.) that are in close proximity (e.g., distance, travel time, etc.) to each other (e.g., closely associated) may be grouped together. Moreover, service requests 137 that are close in time (e.g., request time, estimated arrival time, delivery time, etc.) may also be grouped together. For instance, the clustering definition model 150A can define an ephemeral cluster 401A-C with a period of time (e.g., time range) indicating a threshold duration of time in which the service requests 137 are closely associated. The period of time can also be determined based on historical data 155B indicating that service requests 137 received during a period of time (e.g., breakfast period, lunch, period, rush hours, etc.) are closely associated. As such, the cluster definition model 150A can determine one or more ephemeral clusters 401A-C based on a cluster analysis that groups closely associated service requests 137 by location proximity and time proximity.

The ephemeral clusters 401A-C can include computing processes that exist for a defined duration of time. By way of example, the cluster definition model 150A can create a dedicated computing environment (e.g., node, container, cluster, etc.) for the ephemeral clusters 401A-C to persist for the defined period of time. The ephemeral clusters 401A-C can utilize computing resources associated with the dedicated computing environment to store, manage, and update assignments to the respective cluster. Upon the end of the defined period of time, the ephemeral clusters 401A-C can terminate thus terminating the dedicated computing environment.

The ephemeral clusters 401A-C can be associated with geographic regions. For instance, the cluster definition model 150A can group or organize the service requests 137 by defining proximity associations (e.g., location data) that correspond to defined boundaries of geographic region. The proximity associations can form the basis of the outer boundaries of a radius or shape associated with a geographic region as shown in FIG. 3.

Once the ephemeral clusters 401A-C have been defined, a machine-learned assignment model 150B can determine which service requests 137 should be assigned to the ephemeral clusters 401A-C.

The machine-learned assignment model 150B may be or otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The assignment model 150B may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled service requests assignments that have labels indicating the aggregated locations and times of service requests in a geographic region. In some examples, the training data may include simulated training data (e.g., training data obtained from simulated scenarios, inputs, configurations, geographic regions, etc.).

Additionally, or alternatively, the model trainer(s) may perform unsupervised training techniques using unlabeled training data. By way of example, the model trainer(s) may train one or more components of a machine-learned model to perform parking space detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The assignment model 150B can assign service requests 137 to the ephemeral cluster during the defined period of time, based on one or more parameters. For instance, a machine-learned distribution estimation model 150C can determine a threshold gratuity 245 and an estimated earning distribution 255 for each of the ephemeral clusters 401A-C.

The distribution estimation model 150C may be or otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The distribution estimation model 150C may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labelled service requests assignments that have labels indicating the threshold gratuity levels, earning distributions, etc. In some examples, the training data may include simulated training data (e.g., training data obtained from simulated scenarios, inputs, configurations, etc.).

Additionally, or alternatively, the model trainer(s) may perform unsupervised training techniques using unlabeled training data. By way of example, the model trainer(s) may train one or more components of a machine-learned model to perform parking space detection through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The distribution estimation model 150C can be trained to determine an estimated earning distribution (e.g., pre-determined gratuity) associated with the organized service requests 137. For instance, the distribution estimation model 150C can aggregate the associated gratuity data 230 associated with each of the service requests 137 within each grouping. In an embodiment, the distribution estimation model 150C can determine predicted gratuity data by analyzing user preferences 210 indicating gratuity preferences (e.g. default gratuity data, etc.) or historical data 155B indicating previous gratuity data associated with similar service requests 137.

In an embodiment, the gratuity data 230 can be derived for each of the service requests 137. By way of example, gratuity data 230 can be determined for a service requests 137 based on a points system. The point system may consider additional factors which can influence gratuity data 230 such as the time (e.g., traffic, rush hour, etc.), distance, trip complexity, etc. associated with each service request 137. In an embodiment, the distribution estimation model 150C can track in real time gratuity data 230 associated with each grouping (e.g., as additional service requests 137 are received) and points accumulated to determine the estimated earning distribution. Real-time gratuity data can also include gratuity offered after the service request 137 received by the network system 130 or has been fulfilled. The distribution estimation model 150C can estimate the ‘points’ of a given service request 137 and then multiply that by the estimated average gratuity data 230 per service request to determine the estimated earning distribution. In some implementations, the computation of the estimated earning distribution can be biased downward (e.g., lower). For instance, estimated earning distribution can include a guaranteed (e.g., pre-determined) estimated earning distribution.

In an embodiment, the distribution estimation model 150C can determine the estimated earning distribution that balances market factors. For instance, the distribution estimation model estimation model 150C can analyze all service requests within each grouping and determine an estimated earning distribution which avoids adverse impacts to the surrounding area. By way of example, the distribution estimation model 150C can analyze 10 service requests where the average gratuity data 230 indicates (e.g. or is computed to indicate) an average gratuity of $10 per request. For instance, some service requests 137 may not include any gratuity (e.g., $0 gratuity data) and some may include gratuity higher than $10 (e.g., $20, $15, etc.) which results in an average gratuity across the grouping of $10. The distribution estimation model 150C may determine an estimated earning distribution 255 of $7 dollars to balance market factors within the surrounding area.

For example, by determining an estimated earning distribution of $7, some service requests 137 associated without gratuity (e.g., $0 gratuity data) can be assigned to the ephemeral cluster 401A-C and some service requests 137 with gratuity data exceeding the average (e.g., $15, $20, etc.) can be unassigned. By avoiding service request assignments 402B that simply assign service requests 137 that include “high” or “substantial” gratuity to ephemeral cluster 401A-C, the distribution estimation model 150C can avoid adverse market impact such as increased cancellation rates, decreased service quality, etc. due to “low” or “small” gratuity.

The assignment model 150B can generate service request assignments 402B that assign service requests 137 that satisfy or exceed the estimated earning distribution configured for each ephemeral cluster 401A-C. For instance, the assignment model 150B can consider a threshold gratuity 245 in determining service request assignments 402B.

The distribution estimation model 150C can determine the threshold gratuity 245 for each ephemeral cluster. The threshold gratuity 245 can include a minimum level of gratuity data 230 for the service request to be assigned to an ephemeral cluster. The threshold gratuity 245 can include a single service request 137 or a batch of service requests 137. For instance, the threshold gratuity 245 can ensure that the estimated earning distribution 255 (e.g., pre-determined gratuity) is satisfied or exceeded throughout the period of time (e.g., lifecycle duration of the ephemeral clusters 401A-C).

By way of example, the distribution estimation model 150C can determine an estimated earning distribution of $5 dollars for ephemeral cluster 401A. The estimated earning distribution may be biased downward from $7 dollars. The distribution estimation model 150C can determine a threshold gratuity of $5 dollars to ensure that the earning distribution (e.g., pre-determined gratuity) is satisfied for the period of time. The assignment model 150B can analyze the organized (e.g., grouped) service request 137 output by the cluster definition model 150A and generate service request assignments 402B that satisfy or exceed the threshold gratuity 245.

In an embodiment, additional service requests 137 may be received by the network system 130 during the period of time. The cluster definition model 150A may group the additional service requests 137 (e.g., based on the associations (e.g., locations, time, etc.)) and the assignment model 150B can generate service request assignments 402B for ephemeral clusters 401A-C where the threshold gratuity has been satisfied.

In an embodiment, the threshold gratuity 245 can change during the period of time. For instance, real-time gratuity data (e.g., gratuity data received after submission of the service request) can be accessed by the distribution estimation model 150C to generate an updated threshold gratuity for an ephemeral cluster. By way of example, a user may provide additional gratuity after the service request has been fulfilled based on excellent service from the service provider. The additional gratuity may increase the aggregated gratuity received across all of the service request assignments associated with the respective ephemeral cluster. As such the threshold gratuity can be lowered to allow for additional service requests 137 to be assigned to the ephemeral cluster 401A-C while maintaining the estimated earning distribution.

Once the service request assignments 402B have been generated for the ephemeral clusters 401A-C, the assignment model 150B can access the service provider data 155D to generate service provider assignments 402A to assign service providers, who are available, to the ephemeral clusters 401A-C for fulfillment. While examples herein describe the assignment model 150B as generating both service provider assignments 402A and service requests assignments 402B, the present disclosure is not limited to such embodiment. The assignment model 150B can include one or more sub-models, sub-systems, modules, etc. that perform discrete tasks related to the generation of service provider assignments 402 and service request assignments.

The assignment model 150B can analyze the service provider data 155D and determine service providers to be assigned to respective ephemeral clusters. For instance, the service provider data 155D can include the location of service providers. Service providers in closest proximity or are located within the outer boundaries (e.g., within the radius 240) of the ephemeral clusters 401A-C can be assigned to the ephemeral clusters 401A-C.

In an embodiment, the assignment model 150B can generate service provider assignments 402A assigning service providers who are further away from the locations of the service request assignments 402B for an ephemeral cluster 401A-C than other service providers who are in closer proximity. For instance, the assignment model 150B can consider the past performance of service providers to reward, incentives, etc. service provider by offering a guaranteed gratuity (e.g., estimated earning distribution).

By way of example, the assignment model 150B can determine that service provider 106A has a location 1 mile away from several of the service request assignments 402B associated with ephemeral cluster 401B. Service provider 106B may be located 3 miles away from the nearest service request assignment 402B associated with ephemeral cluster 401B. However, the assignment model 150B can consider service provider 106B may consider performance metrics associated with respective service providers 106A-B such as their acceptance rate, consumer (e.g., user) rating, cancellation rate, etc. In an embodiment, service provider 106B may have more positive performance metrics than service provider 106A and the assignment model 150B can generate a service provider assignment 402A to assign service provider 106B to ephemeral cluster 401B.

Once the assignment model 150B has generated a service provider assignment 402A, the gratuity aggregation system 150 can generate output 404. The output 404 can be transmitted (e.g., over one or more networks) to the service provider devices 110A-B. The output 404 can include one or more command instructions to generate a display via a user interface of the service provider devices 110A-B. The display can depict an invitation for the service provider 106A-B to “opt-in” and depict the predetermined gratuity (e.g., estimated earning distribution).

The service provider 106A-B can provide user input to accept (e.g., “opt-in”) the invitation to join the ephemeral cluster 401A-C by “clicking”, “selecting”, etc. via the user interface display. Alternatively, the service provider 106A-B can reject the invitation by provider user input (e.g., click, select, etc.) via the user interface display to decline the invitation. In response to user input “opting-in”, the assignment model 150B can execute the service provider assignments 402A assigning the service providers 106A-B to the ephemeral clusters 401A-C. Once assigned, the service providers may be matched to service requests for fulfillment.

Upon expiration of the time period associated with the ephemeral clusters 401A-C, the gratuity aggregation system 150 can trigger, at a minimum, the estimated earning distribution to be paid to each of the service providers 106A-B. For instance, in an embodiment, the estimated earning distribution may be higher than the actual aggregated gratuity received across the plurality of service requests assignments 402B. As such, the aggregated gratuity aggregation system 150 can distribute the difference to the service providers 106A-B. In an embodiment, the estimated earning distribution may be lower than the actual aggregated gratuity received across the plurality of service requests assignments 402B and the gratuity aggregation system 150 can manage the underspend accumulated by triggering payment of the underspend proportional to the gratuity data 230, points, etc. for each service request assigned to the ephemeral cluster 401A-C.

In some embodiments, the gratuity aggregation system 150 can utilize the output of each of the cluster definition model 150A, assignment model 150B, and distribution estimation model 150C including the actual payouts to further train the cluster definition model 150A, assignment model 150B, and distribution estimation models 150C. By way of example, the outputs can be used to update one or more weights associated with the machine-learned models to improve predictions and decisions.

In an embodiment, the monitoring system 403 can be configured to monitor the cluster definition model 150A, assignment model 150B, and distribution estimation model 150C in real-time to ensure that goals and objectives are satisfied. The monitoring system can include software running on one or more servers of the gratuity aggregation system 150. In an embodiment, the monitoring system 403 can include software which communicates with the gratuity aggregation system 150.

The monitoring system 403 can include pre-defined rules or parameters that define acceptable output for each of the machine-learned models. For instance, the monitoring system 403 can receive output from the cluster definition model 150A indicating that the time period 250 associated with ephemeral cluster 401C is 4 PM to 11 PM and includes a radius of 25 miles. Based on an objective to reduce cancellations for service requests 137 not assigned to ephemeral cluster 401C, the monitoring system 403 may determine the size and duration of ephemeral cluster 401C is too large, too long, and provide input to the cluster definition model 150A. By way of example, the input can include a series of commands or functions to sub-divide (e.g., nested ephemeral clusters) the ephemeral cluster 401C, reduce the timer period 250, etc., such that the ephemeral cluster satisfies the objective to reduce cancellations.

In another embodiment, the monitoring system 403 can analyze the payout (e.g., actual earning distribution) data generated at the termination of an ephemeral cluster. For example, the monitoring system 403 can generate input to bias the estimated earning distribution further downward when an overspend (e.g., estimated earning distribution higher than actual earning distribution) occurs so that when similar ephemeral clusters 401A-C (e.g., similar location, time period, requesting users, etc.) are determined, the overspend is eliminated. The monitoring system 403 can also monitor for changed conditions such as changes in service provider data 155D, execution data, etc. to influence decisions of the gratuity aggregation system 150 in real-time.

While examples herein describe specific examples of monitoring system actions and input, one or ordinary skill in the art will appreciate that the monitoring system 403 can perform any action or provide any input to the gratuity aggregation system 150 to influence the output and ensure satisfaction of goals or objectives.

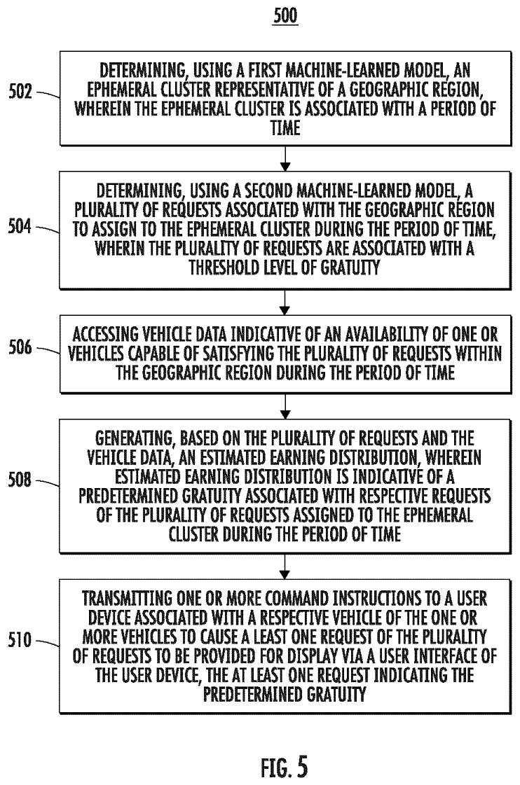

FIG. 5 depicts a flowchart diagram of an example method according to example embodiments of the present disclosure. One or more portion(s) of the method 500 can be implemented by one or more computing devices such as, for example, the computing devices/systems described in FIG. 1, FIG. 4, etc. Moreover, one or more portion(s) of the method 500 can be implemented as an algorithm on the hardware components of the device(s) described herein (e.g., as in FIG. 1, FIG. 4, etc.). For example, a computing system can include one or more processors and one or more non-transitory, computer-readable media storing instructions that are executable by the one or more processors to cause the computing system to perform operations, the operations including one or more of the operations/portions of method 500. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At (502), method 500 can include determining, using a first machine-learned model, an ephemeral cluster representative of a geographic region, wherein the ephemeral cluster is associated with a period of time. For instance, a cluster definition model 150A can access a plurality service requests 137 defining locations within a geographic region at various times. The cluster definition model 150A can perform one or more cluster analysis to determine, based on the associated locations (e.g., drop-off locations 220, merchant locations, etc.) and the associated times (e.g., request time, estimated arrival time, etc.), ephemeral clusters 401A-C that correspond to the geographic regions defined by the service requests 137.

For example, the ephemeral clusters 401A-C may include a radius with outer boundaries defined by the location and time associations (e.g., distance proximity, location proximity, time proximity, etc.) of the service requests 137. The outer boundaries (e.g., location proximity) may be indicative of the association basis for which the service requests 137 are grouped.

By way of example, 20 service requests 137 may be accessed by the gratuity aggregation system 150. The 20 service requests 137 may be received by the network system 130 over a 30 minute span of time and indicate various locations within a 6 mile radius. The cluster definition model 150A, based on a cluster analysis, may group 10 of the service requests 137 together based on associations (e.g., distance proximity, time proximity, etc.). In an embodiment, the cluster definition model 150A may determine ephemeral cluster 401A which includes a radius 240 (e.g., 2 mile radius, 1 mile radius, etc.) that matches the outermost boundaries (e.g., of the geographic region) that encapsulate the 10 closely associated service requests 137.

In an embodiment, the cluster definition model 150A may also determine a time period associated with ephemeral cluster 401A. For instance, the 10 requests may have been received by the network system between 11:30 AM and 11:45 AM. Based on historical data 155B indicating a “lunch” time period that spans from 11:30 AM to 1 PM, the cluster definition model 150A may define a time period of 11:30 to 1 PM to ephemeral cluster 401A.

At (504), method 500 can include determining, using a second machine-learned model, a plurality of requests associated with the geographic region to assign to the ephemeral cluster during the period of time, wherein the plurality of requests are associated with a threshold level of gratuity. For instance, an assignment machine-learned model 150B can analyze the 10 grouped service requests 137 and generate service request assignments 402B to assign some or all of the grouped service requests 137 to ephemeral cluster 401A. In an embodiment, the assignment model 150B can generate service request assignments 402B for subsequent service requests 137 that are received during the period of time.

For example, the assignment model 150B can analyze the gratuity data 230 associated with each of the 10 grouped service requests 137. The gratuity data 230 can indicate an actual or predicted (e.g., points, etc.) level of gratuity associated with each of the 10 service request 137. In an embodiment, the assignment model 150B can compare the gratuity data 230 to a threshold gratuity 245.

The distribution estimation model 150C can determine the threshold gratuity 245 for ephemeral cluster 401A. The threshold gratuity 245 can include a minimum level, range, etc. of gratuity data 230 needed for the service requests 137 to be assigned to ephemeral cluster 401A. The threshold gratuity 245 can be based on a single service request 137 or a batch of service requests 137. For instance, the threshold gratuity 245 can indicate that the gratuity data 230 for each of the 10 service requests must be at least $5 or indicate that a batch of 5 service requests 137 must have an average of $5.

To do so, the distribution estimation model 150C can determine an aggregated gratuity (e.g., gratuity data 230) across all of the 10 service requests 137 grouped for ephemeral cluster 401A. Based on the aggregated average, the distribution estimation model 150C can determine a threshold gratuity 245 that maintains the average gratuity for ephemeral cluster 401A. In an embodiment, the distribution estimation model 150C can determine a threshold gratuity that creates a higher average gratuity than the 10 grouped service request 137. For instance, the distribution estimation model 150C can determine a threshold gratuity 245 of $8 based an aggregated average of $5 across the 10 grouped service requests 137. By determining a higher $8 threshold gratuity 245, the distribution estimation model 150C determine a can higher estimated earning distribution for ephemeral cluster 401A to incentivize service providers who are invited to “opt-in” to accept the invitation. As such, the assignment model 150B can generate service request assignments 402B to assign the portion of the 10 grouped service requests 137 which satisfy the $8 dollar threshold gratuity 245.

At (506), method 500 can include accessing vehicle data indicative of an availability of one or vehicles capable of satisfying the plurality of requests within the geographic region during the period of time. For instance, the assignment model 150B can access the service provider data 155D and determine a number of service providers (e.g., to be assigned to respective ephemeral clusters. For instance, the service provider data 155D can include the location of service providers. Service providers that are in closest proximity or are located within the outer boundaries (e.g., within the radius 240) of ephemeral cluster 401A can be assigned. In an embodiment service providers further away can also be assigned.

The assignment model 150B can determine the number of service providers needed to fulfill the service request assignments 402B assigned to ephemeral cluster 401A. For instance, 5 of the 10 service request 137 may satisfy the $8 threshold gratuity 245 and be assigned to ephemeral cluster 401A. Based on 5 service request assignments 402B associated with ephemeral cluster 401A, the assignment model 150B may determine that 2 service providers are needed to satisfy the 5 service request assignments 402B. For instance, the assignment model 150B can identify 2 available service providers and generate service provider assignments 402A for assigning the 2 service providers to ephemeral cluster 401A.

At (508), method 500 can include generating, based on the plurality of requests and the vehicle data, an estimated earning distribution, wherein estimated earning distribution is indicative of a predetermined gratuity associated with respective requests of the plurality of requests assigned to the ephemeral cluster during the period of time. For instance, based on the 5 service request assignments 402B and the 2 service providers needed to fulfill the 5 service request assignments 402B, the distribution estimation model 150C can determine an estimated earning distribution.

In an embodiment, the estimated earning distribution can be based on an aggregated total of gratuity data 230 across all service request assignments 402 associated with ephemeral cluster 401A divided proportional to service providers. For instance, the 5 service requests assignments may indicate gratuity data of $10, $12, $8, $11, and $9 respectively for a total of $50. Based on a total of $50 of gratuity for ephemeral cluster 401A and 2 service providers, the distribution estimation model 150C can determine an estimated earning distribution (e.g., guaranteed gratuity) of $10 per service request assignment. While examples herein describe arithmetic calculations, the estimated earning distribution can also be calculated using a points system that considers environmental factors such as time (e.g., traffic etc.), distance, trip complexity, etc. associated with each service request.

At (510), method 500 can include transmitting one or more command instructions to a user device associated with a respective vehicle of the one or more vehicles to cause at least one request of the plurality of requests to be provided for display via a user interface of the user device, the at least one request indicating the predetermined gratuity. For instance, the gratuity aggregation system 150 can generate output 404 to user devices (e.g., service provider device 110A-B, etc.) associated with the service provider assignments 402A. The output 404 can include command instructions to display via a user interface of the user devices an invitation to “opt-in” or join ephemeral cluster 401A and display the predetermined gratuity (e.g., estimated earning distribution) of $10 per service request assignment 402B fulfilled. Once the two service providers accept (e.g., “opt-in”) the invitation to join the ephemeral cluster 401A by providing user input (e.g., via the service provider device 110A-B, etc.) the assignment model 150B can execute the service provider assignments 402A and assign the 2 service providers to ephemeral cluster 401A. Once assigned, the service providers may be matched to service requests for fulfillment.

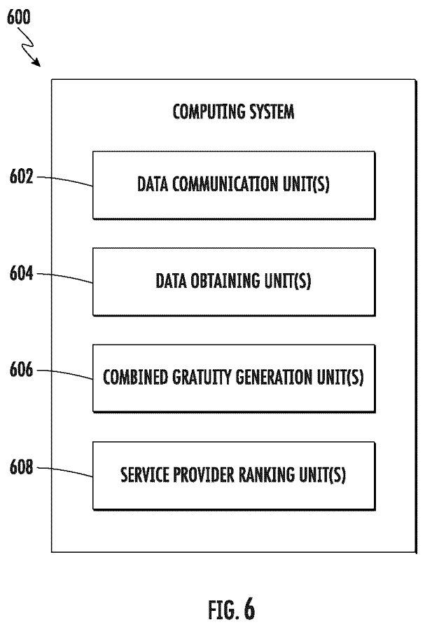

Various means can be configured to perform the methods and processes described herein. For example, FIG. 6 depicts an example computing system 600 that includes various means according to example embodiments of the present disclosure. The computing system 600 can be or otherwise include, for example, an operations computing system, etc. The computing system 600 can include data communication unit(s) 602, data obtaining unit(s) 604, combined gratuity generation unit(s) 606, service provider ranking unit(s) 608, or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware.

The means can be programmed to perform one or more algorithm(s) for carrying out the operations and functions described herein. For instance, the means (e.g., data communication unit(s) 602) can be configured to communicate data indicative of a request for a service provider to perform a delivery service associated with a delivery or transportation service request.

In addition, the means (e.g., data obtaining unit(s) 604) can be configured to obtain data associated with a multi-service provider delivery service request. For example, multi-service provider delivery service requests can be indicative of a pick-up location, merchant, item, or drop-off location associated with a multi-service provider delivery service request. In addition, in some implementations, the means (e.g., the data obtaining unit(s) 604) can obtain data associated with one or more service providers, one or more merchants, or map data indicative of one or more geographic regions.

In addition, the means (e.g., combined gratuity generation unit(s) 606) can be configured to generate one or more estimated earning distributions for a plurality of ephemeral clusters. For example, the estimated earning distributions can include guaranteed (pre-determined earning) for service providers who “opt-in” to fulfill service requests assigned to one or more ephemeral clusters.

In addition, the means (e.g., service provider ranking unit(s) 608) can be configured to determine a ranking of service providers (e.g., of available service providers) for assignment to ephemeral clusters. In addition, or alternatively, the service provider listing can be ranked based on performance metrics, contextual data, historical data, or user data.

These described functions of the means are provided as examples and are not meant to be limiting. The means can be configured for performing any of the operations and functions described herein.

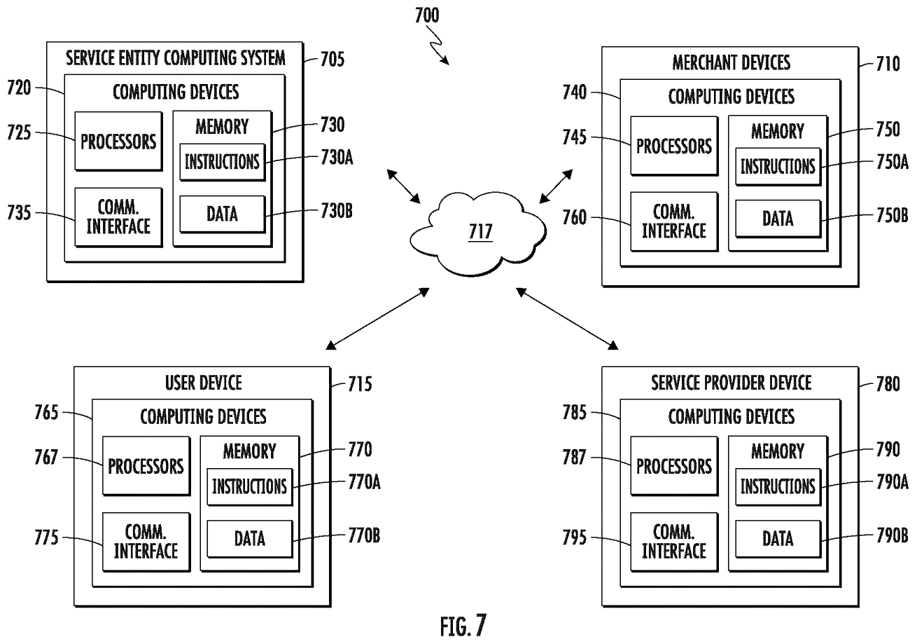

FIG. 7 depicts a block diagram of an example system 700 for implementing systems and methods according to example embodiments of the present disclosure. The example system 700 illustrated in FIG. 7 is provided as an example only. The components, systems, connections, or other aspects illustrated in FIG. 7 are optional and are provided as examples of what is possible, but not required, to implement the present disclosure. The example system 700 can include a service entity computing system 705 (e.g., that is associated with a delivery service entity or service provider). The example system 700 can include one or more merchant devices 710 (e.g., that are associated with one or more merchants). The example system 700 can include one or more user devices 715 (e.g., user device of the user). The example system 700 can include one or more service provider devices 780 (e.g., user device of the operator, user device of the vehicle). One or more of the service entity computing system 705, the merchant device 710, the user device 715, or the service provider device 780 can be communicatively coupled to one another over one or more communication network(s) 717. The networks 717 can correspond to any of the networks described herein.

The computing device(s) 720 of the service entity computing system 705 can include processor(s) 725 and a memory 730. The one or more processors 725 can be any suitable processing device (e.g., a processor core, a microprocessor, an ASIC, a FPGA, a controller, a microcontroller) and can be one processor or a plurality of processors that are operatively connected. The memory 730 can include one or more non-transitory computer-readable storage media, such as RAM, ROM, EEPROM, EPROM, one or more memory devices, flash memory devices, data registrar, etc., and combinations thereof.

The memory 730 can store information that can be accessed by the one or more processors 725. For example, the memory 730 (e.g., one or more non-transitory computer-readable storage mediums, memory devices) can include computer-readable instructions 730A that can be executed by the one or more processors 725. The instructions 730A can be software written in any suitable programming language or can be implemented in hardware. Additionally, or alternatively, the instructions 730A can be executed in logically or virtually separate threads on processor(s) 725.

For example, the memory 730 can store instructions 730A that when executed by the one or more processors 725 cause the one or more processors 725 (the service entity computing system 705) to perform operations such as any of the operations and functions of the computing system(s) (e.g., operations computing system) described herein (or for which the system(s) are configured), one or more of the operations and functions for communicating between the computing systems, one or more portions/operations of method 500, or one or more of the other operations and functions of the computing systems described herein.

The memory 730 can store data 730B that can be obtained (e.g., acquired, received, retrieved, accessed, created, stored). The data 730B can include, for example, any of the data/information described herein. In some implementations, the computing device(s) 720 can obtain data from one or more memories that are remote from the service entity computing system 705.

The computing device(s) 720 can also include a communication interface 735 used to communicate with one or more other system(s) remote from the service entity computing system 705, such as merchant device 710, user device 715, or service provider device 780. The communication interface 735 can include any circuits, components, software, etc. for communicating via one or more networks (e.g., network(s) 717). The communication interface 735 can include, for example, one or more of a communications controller, receiver, transceiver, transmitter, port, conductors, software or hardware for communicating data.

The merchant device 710 can include one or more computing device(s) 740 that are remote from the service entity computing system 705, the user device 715, and the service provider device 780. The computing device(s) 740 can include one or more processors 745 and a memory 750. The one or more processors 745 can be any suitable processing device (e.g., a processor core, a microprocessor, an ASIC, a FPGA, a controller, a microcontroller) and can be one processor or a plurality of processors that are operatively connected. The memory 750 can include one or more tangible, non-transitory computer-readable storage media, such as RAM, ROM, EEPROM, EPROM, one or more memory devices, flash memory devices, data registrar, etc., and combinations thereof.

The memory 750 can store information that can be accessed by the one or more processors 745. For example, the memory 750 (e.g., one or more tangible, non-transitory computer-readable storage media, one or more memory devices) can include computer-readable instructions 750A that can be executed by the one or more processors 745. The instructions 750A can be software written in any suitable programming language or can be implemented in hardware. Additionally, or alternatively, the instructions 750A can be executed in logically or virtually separate threads on processor(s) 745.

For example, the memory 750 can store instructions 750A that when executed by the one or more processors 45 cause the one or more processors 745 to perform operations such as any of the operations and functions of the computing system(s) (e.g., merchant server) described herein (or for which the system(s) are configured), one or more of the operations and functions for communicating between computing systems, one or more portions/operations of method 500, or one or more of the other operations and functions of the computing systems described herein. The memory 750 can store data 750B that can be obtained. The data 750B can include, for example, any of the data/information described herein.

The computing device(s) 740 can also include a communication interface 760 used to communicate with one or more system(s) that are remote from the merchant device 710. The communication interface 760 can include any circuits, components, software, etc. for communicating via one or more networks (e.g., network(s) 717). The communication interface 760 can include, for example, one or more of a communications controller, receiver, transceiver, transmitter, port, conductors, software or hardware for communicating data.

The user device 715 can include one or more computing device(s) 765 that are remote from the service entity computing system 705, the merchant device 1310, and the service provider device 780. The computing device(s) 765 can include one or more processors 767 and a memory 770. The one or more processors 767 can be any suitable processing device (e.g., a processor core, a microprocessor, an ASIC, a FPGA, a controller, a microcontroller) and can be one processor or a plurality of processors that are operatively connected. The memory 770 can include one or more tangible, non-transitory computer-readable storage media, such as RAM, ROM, EEPROM, EPROM, one or more memory devices, flash memory devices, data registrar, etc., and combinations thereof.

The memory 770 can store information that can be accessed by the one or more processors 767. For example, the memory 770 (e.g., one or more tangible, non-transitory computer-readable storage media, one or more memory devices) can include computer-readable instructions 770A that can be executed by the one or more processors 767. The instructions 770A can be software written in any suitable programming language or can be implemented in hardware. Additionally, or alternatively, the instructions 770A can be executed in logically or virtually separate threads on processor(s) 767.

For example, the memory 770 can store instructions 770A that when executed by the one or more processors 767 cause the one or more processors 767 to perform operations such as any of the operations and functions of the computing system(s) (e.g., user devices) described herein (or for which the user device(s) are configured), one or more of the operations and functions for communicating between systems, one or more portions/operations of method 500, or one or more of the other operations and functions of the computing systems described herein. The memory 770 can store data 770B that can be obtained. The data 770B can include, for example, any of the data/information described herein.

The computing device(s) 765 can also include a communication interface 775 used to communicate computing device/system that is remote from the user device 715, such as merchant device 710, service entity computing system 705, or service provider device 780. The communication interface 775 can include any circuits, components, software, etc. for communicating via one or more networks (e.g., network(s) 717). The communication interface 775 can include, for example, one or more of a communications controller, receiver, transceiver, transmitter, port, conductors, software or hardware for communicating data.

The computing device(s) 785 of the service provider device 780 can include processor(s) 1387 and a memory 790. The one or more processors 787 can be any suitable processing device (e.g., a processor core, a microprocessor, an ASIC, a FPGA, a controller, a microcontroller) and can be one processor or a plurality of processors that are operatively connected. The memory 790 can include one or more non-transitory computer-readable storage media, such as RAM, ROM, EEPROM, EPROM, one or more memory devices, flash memory devices, data registrar, etc., and combinations thereof.

The memory 790 can store information that can be accessed by the one or more processors 787. For example, the memory 790 (e.g., one or more non-transitory computer-readable storage mediums, memory devices) can include computer-readable instructions 790A that can be executed by the one or more processors 787. The instructions 790A can be software written in any suitable programming language or can be implemented in hardware. Additionally, or alternatively, the instructions 790A can be executed in logically or virtually separate threads on processor(s) 787.

For example, the memory 790 can store instructions 790A that when executed by the one or more processors 787 cause the one or more processors 787 (the service provider device 780) to perform operations such as any of the operations and functions of the display device(s) described herein (or for which such devices are configured), one or more of the operations and functions for communicating between the computing systems/devices, one or more portions/operations of method 500, or one or more of the other operations and functions of the computing systems described herein.

The memory 790 can store data 790B that can be obtained (e.g., acquired, received, retrieved, accessed, created, stored). The data 790B can include, for example, any of the data/information described herein. In some implementations, the computing device(s) 785 can obtain data from one or more memories that are remote from the service provider device 1380.

The computing device(s) 785 can also include a communication interface 795 used to communicate with one or more other system(s) remote from the service provider device 780, such as merchant device 710, user device 715, or service entity computing system 705. The communication interface 795 can include any circuits, components, software, etc. for communicating via one or more networks (e.g., network(s) 717). The communication interface 795 can include, for example, one or more of a communications controller, receiver, transceiver, transmitter, port, conductors, software or hardware for communicating data.

The network(s) 717 can be any type of network or combination of networks that allows for communication between devices. In some implementations, the network(s) 717 can include one or more of a local area network, wide area network, the Internet, secure network, cellular network, mesh network, peer-to-peer communication link or some combination thereof and can include any number of wired or wireless links. Communication over the network(s) 717 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computer-implemented method comprising:
determining, using a first machine-learned model, an ephemeral cluster representative of a geographic region, wherein the ephemeral cluster is associated with a period of time;
determining, using a second machine-learned model, a plurality of requests associated with the geographic region to assign to the ephemeral cluster during the period of time, wherein the plurality of requests are associated with a threshold level of gratuity;
accessing vehicle data indicative of an availability of one or more service providers capable of satisfying the plurality of requests within the geographic region during the period of time;
generating, based on the plurality of requests and the vehicle data, an estimated earning distribution, wherein the estimated earning distribution is indicative of a predetermined gratuity associated with respective requests of the plurality of requests assigned to the ephemeral cluster during the period of time; and
transmitting one or more command instructions to a user device associated with a respective service provider of the one or more service providers to cause at least one request of the plurality of requests to be provided for display via a user interface of the user device, the at least one request indicating the predetermined gratuity.

2. The computer-implemented method of claim 1, further comprising:
receiving user input data from the user device, the user input data indicating an acceptance of the predetermined gratuity; and
assigning the respective service provider to the ephemeral cluster during the period of time.

3. The computer-implemented method of claim 1, further comprising:
monitoring the ephemeral cluster during the period of time to identify one or more changed conditions, the one or more changed conditions indicative of at least one of a change in the vehicle data; and
based on the one or more changed conditions, generating an updated earning distribution during the period of time.

4. The computer-implemented method of claim 3, wherein the one or more changed conditions is associated with the threshold level of gratuity.

5. The computer-implemented method of claim 1, wherein the vehicle data comprises metrics associated with respective service providers of the one or more service providers, the metrics comprising at least one of (i) an acceptance rate, (ii) a consumer rating, or (iii) a cancel rate.

6. The computer-implemented method of claim 1, further comprising:
accessing execution data associated with the ephemeral cluster, the execution data indicative of real-time execution of the plurality of requests assigned to the ephemeral cluster during the period of time; and
based on the execution data, determining an actual earning distribution across the ephemeral cluster.

7. The computer-implemented method of claim 6, further comprising:
determining that the actual earning distribution is above or below the estimated earning distribution; and
determining an updated estimated earning distribution based on the actual earning distribution being above or below the estimated earning distribution, wherein the updated estimated earning distribution is associated with subsequent respective service providers assigned to the ephemeral cluster.

8. The computer-implemented method of claim 1 further comprising:
determining, using the first machine-learned model, a plurality of ephemeral clusters representative of a plurality of geographic regions, wherein the plurality of geographic regions are associated with a threshold proximity to each other.

9. The computer-implemented method of claim 1, further comprising:
accessing assignment data indicative of one or more assignments of the one or service providers to one or more ephemeral clusters; and
based on the assignment data, determining a size of the ephemeral cluster wherein the size correlates to a size of the geographic region associated with the ephemeral cluster.

10. The computer-implemented method of claim 1, wherein the period of time is associated with at least one of (i) breakfast hours, (ii) lunch hours, (iii) dinner hours, or (iv) a rush hour period.

11. A computing system comprising:
one or more processors; and
one or more non-transitory computer-readable media storing instructions that are executable by the one or more processors to cause the computing system to perform operations, the operations comprising:
determining, using a first machine-learned model, an ephemeral cluster representative of a geographic region, wherein the ephemeral cluster is associated with a period of time;
determining, using a second machine-learned model, a plurality of requests associated with the geographic region to assign to the ephemeral cluster during the period of time, wherein the plurality of requests are associated with a threshold level of gratuity;
accessing vehicle data indicative of an availability of one or more service providers capable of satisfying the plurality of requests within the geographic region during the period of time;
generating, based on the plurality of requests and the vehicle data, an estimated earning distribution, wherein the estimated earning distribution is indicative of a predetermined gratuity associated with respective requests of the plurality of requests assigned to the ephemeral cluster during the period of time; and
transmitting one or more command instructions to a user device associated with a respective service provider of the one or more service providers to cause at least one request of the plurality of requests to be provided for display via a user interface of the user device, the at least one request indicating the predetermined gratuity.

12. The computing system of claim 11, wherein the operations further comprise:
receiving user input data from the user device, the user input data indicating an acceptance of the predetermined gratuity; and
assigning the respective service provider to the ephemeral cluster during the period of time.

13. The computing system of claim 11, wherein the operations further comprise:
monitoring the ephemeral cluster during the period of time to identify one or more changed conditions, the one or more changed conditions indicative of at least one of a change in the vehicle data; and
based on the one or more changed conditions, generating an updated earning distribution during the period of time.

14. The computing system of claim 12, wherein the one or more changed conditions is associated with the threshold level of gratuity.

15. The computing system of claim 11, wherein the vehicle data comprises metrics associated with respective service providers of the one or more service providers, the metrics comprising at least one of (i) an acceptance rate, (ii) a consumer rating, or (iii) a cancel rate.

16. The computing system of claim 11, wherein the operations further comprise:
accessing execution data associated with the ephemeral cluster, the execution data indicative of real-time execution of the plurality of requests assigned to the ephemeral cluster during the period of time; and
based on the execution data, determining an actual earning distribution across the ephemeral cluster.

17. The computing system of claim 16, wherein the operations further comprise:
determining that the actual earning distribution is above or below the estimated earning distribution; and
determining an updated estimated earning distribution based on the actual earning distribution being above or below the estimated earning distribution, wherein the updated estimated earning distribution is associated with subsequent respective service providers assigned to the ephemeral cluster.

18. The computing system of claim 11, wherein the operations further comprise:
determining, using the first machine-learned model, a plurality of ephemeral clusters representative of a plurality of geographic regions, wherein the plurality of geographic regions are associated with a threshold proximity to each other.

19. The computing system of claim 11, wherein the operations further comprise:
accessing assignment data indicative of one or more assignments of the one or service providers to one or more ephemeral clusters; and
based on the assignment data, determining a size of the ephemeral cluster wherein the size correlates to a size of the geographic region associated with the ephemeral cluster.

20. One or more non-transitory computer-readable media storing instructions that are executable by one or more processors to perform operations comprising:
determining, using a first machine-learned model, an ephemeral cluster representative of a geographic region, wherein the ephemeral cluster is associated with a period of time;
determining, using a second machine-learned model, a plurality of requests associated with the geographic region to assign to the ephemeral cluster during the period of time, wherein the plurality of requests are associated with a threshold level of gratuity;
accessing vehicle data indicative of an availability of one or more service providers capable of satisfying the plurality of requests within the geographic region during the period of time;
generating, based on the plurality of requests and the vehicle data, an estimated earning distribution, wherein the estimated earning distribution is indicative of a predetermined gratuity associated with respective requests of the plurality of requests assigned to the ephemeral cluster during the period of time; and
transmitting one or more command instructions to a user device associated with a respective service provider of the one or more service providers to cause at least one request of the plurality of requests to be provided for display via a user interface of the user device, the at least one request indicating the predetermined gratuity.
